(19) United States
(12) Patent Application Publication
(10) Pub. No.: US 2013/0114025 A1
(43) Pub. Date: May 9, 2013

(54) LIQUID CRYSTAL DISPLAY PANEL

(71) Applicants: Dongguan masstop liquid crystal display Co., Ltd., Dongguan City (CN); Wintek Corporation, Taichung City (TW)

(72) Inventors: Tsung-Hsien Lin, Taichung City (TW); Wen-Chun Wang, Taichung City (TW); Chin-Chang Liu, Taichung City (TW); Wan-Jen Tsai, Taichung City (TW)

(73) Assignees: WINTEK CORPORATION, Taichung City (TW); Dongguan Masstop Liquid Crystal Display Co., Ltd., Dongguan City (CN)

(21) Appl. No.: 13/664,403

(22) Filed: Oct. 30, 2012

(30) Foreign Application Priority Data
Nov. 9, 2011 (TW) 100140868

(51) Int. Cl. G02F 1/1335

(52) U.S. Cl. 349/96

(57) ABSTRACT

A liquid crystal display panel includes a first substrate, a second substrate, a polarizing film, a liquid crystal layer, and a plurality of sub-pixels. Each of the sub-pixels includes a first patterned electrode layer, a second patterned electrode layer, and a first insulating layer. The first insulating layer is disposed between the first patterned electrode layer and the second patterned electrode layer. The first patterned electrode layer includes a plurality of first stripe electrodes extending along a first direction, and the second patterned electrode layer includes a plurality of second stripe electrodes extending along a second direction. Each of the first stripe electrodes overlaps the second stripe electrodes in a direction perpendicular to the first substrate.

### BACKGROUND OF THE INVENTION

1. Field of the Invention

The present invention generally relates to liquid crystal display panels, and more particularly, to a liquid crystal display panel having nano-scaled stripe electrodes.

2. Description of the Prior Art

With the continuous progress in display-related techniques, the liquid crystal display panels are utilized in various kinds of consumer electronics, such as flat TVs, laptop computers and cell phones. In order to improve narrow viewing angle issues occurring in liquid crystal display panels, fringe field switching (FFS) liquid crystal display panels have been developed, wherein the main features include that common electrodes and pixel electrodes are disposed in different layers of an array substrate (also known as a thin film transistor substrate), and a wide viewing angle effect may be achieved by an electrical field generated by the common electrode and the corresponding pixel electrode. In conventional liquid crystal display panels, however, light beams from a back light module have to be transmitted through various necessary parts, such as polarizing films, color filters and so forth, and these structures of the conventional display panels are relatively complicated. In contrast, conventional FFS liquid crystal display panels require more fabricating processes than conventional liquid crystal display panels. In light of the above, there is still a need for a simplified structure of FFS liquid crystal display panel, which can omit complicated fabricating steps.

### SUMMARY OF THE INVENTION

The main objective of the invention is to provide a liquid crystal display panel, which has stripe electrodes with nano-scaled line widths and spacing so that an electrode layer inside the panel may provide the desired effects of band-passing and/or polarizing.

To address these and other objectives, a liquid crystal display panel is provided according to one embodiment of the present invention, which comprises a first substrate, a second substrate, a polarizing film, a liquid crystal layer, and a plurality of sub-pixels. The first substrate is disposed opposite to the second substrate. The first substrate has a first inner surface and a first outer surface while the second substrate has a second inner surface and a second outer surface. The first inner surface faces the second inner surface, and the first outer surface and the second outer surface are disposed back to back. The polarizing film is disposed on the second substrate. The liquid crystal layer is disposed between the first substrate and the second substrate, wherein the liquid crystal layer comprises a plurality of liquid crystal molecules. The sub-pixels are disposed on the first inner surface of the first substrate and each of the sub-pixels comprises the components as follows: a first patterned electrode layer, a second patterned electrode layer and a first insulating layer. The first insulating layer is disposed between the first patterned electrode layer and the second patterned electrode layer. The first patterned electrode layer is disposed on the first substrate, wherein the first patterned electrode layer includes a plurality of first stripe electrodes extending along a first direction. The second patterned electrode layer is disposed on the first substrate and includes a plurality of second stripe electrodes extending along a second direction, wherein each of the first stripe electrodes overlaps the second stripe electrodes in a direction perpendicular to the first substrate.

Accordingly, the present invention provides a liquid crystal display panel, where an electrode layer, used to alter the orientation of liquid crystal molecules, has a stripe electrode with nano-scaled line widths and spacing. By adjusting the line widths, spacing and thickness of the nano-scaled stripe electrode, the electrode layer can provide desired band-passing and/or polarizing effects. Therefore, it can replace color filters and polarizing films, and further simplify a structure of the panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are schematic, side view diagrams illustrating a liquid crystal display panel according to a first embodiment of the invention.

FIG. 5 is a schematic, partially enlarged top view diagram illustrating a liquid crystal display panel according to the first embodiment of the invention.

FIGS. 6-8 are schematic, top view diagrams illustrating the orientation of each first stripe electrode and each second stripe electrode in a liquid crystal display panel according to another embodiment of the invention.

FIGS. 9-11 are schematic, side view diagrams illustrating a liquid crystal display panel according to a second embodiment of the invention.

FIGS. 12-14 are schematic, side view diagrams illustrating a liquid crystal display panel according to a third embodiment of the invention.

FIG. 15 is schematic, side view diagram illustrating a liquid crystal display panel according to a forth embodiment of the invention.

### DETAILED DESCRIPTION

In the following description, numerous specific details are given to provide a thorough understanding of the invention. It will, however, be apparent to one skilled in the art that the invention may be practiced without these specific details. Furthermore, some well-known system configurations and process steps are not disclosed in detail, as these should be well-known to those skilled in the art.

Likewise, the drawings showing embodiments of the apparatus are not to scale and some dimensions are exaggerated for clarity of presentation. Also, where multiple embodiments are disclosed and described as having some features in common, like or similar features will usually be described with same reference numerals for ease of illustration and description thereof.

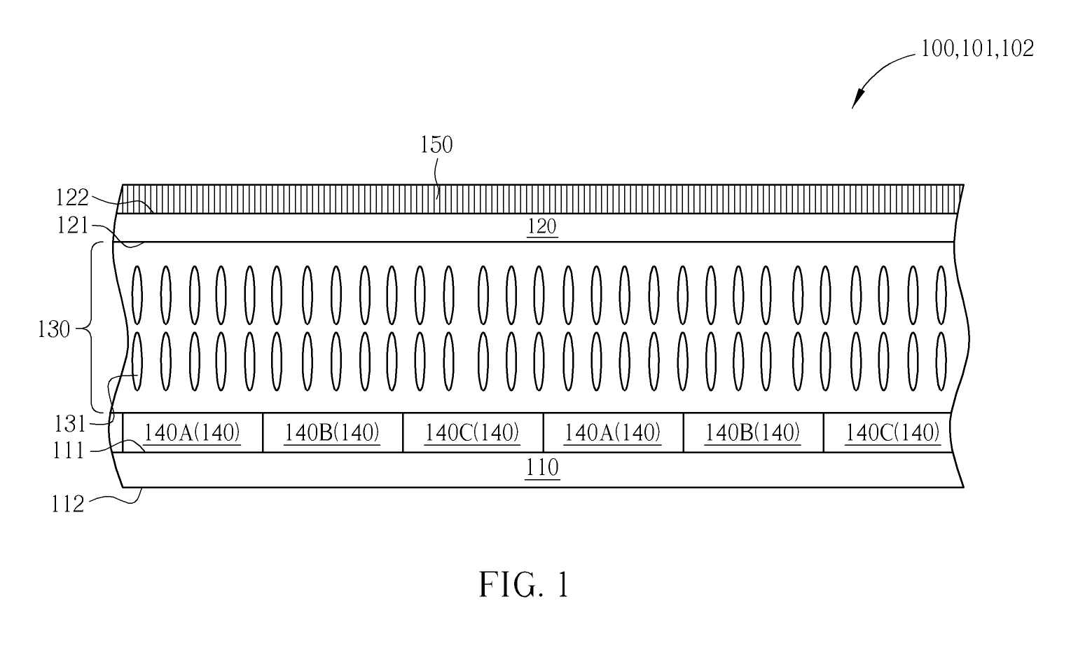

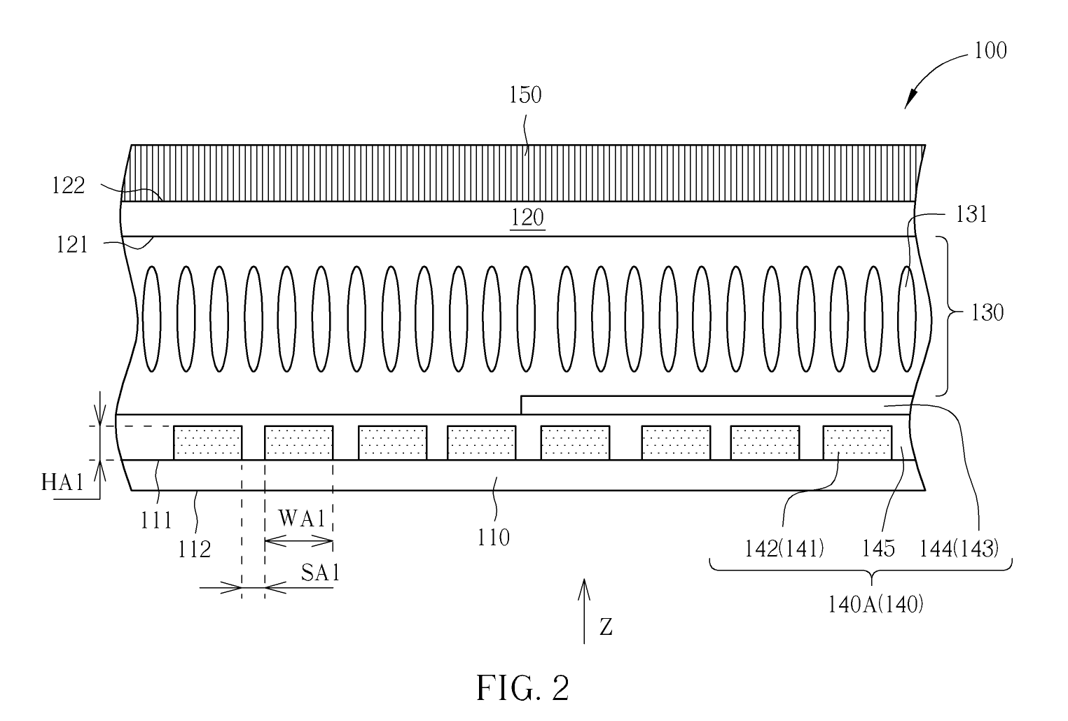

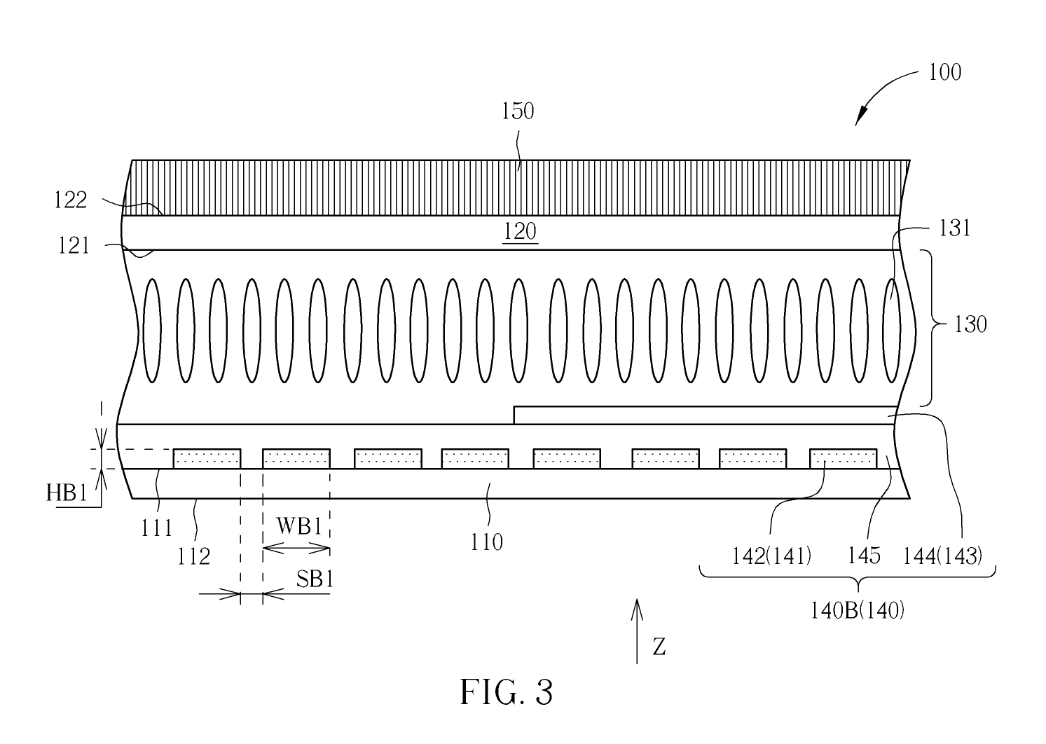

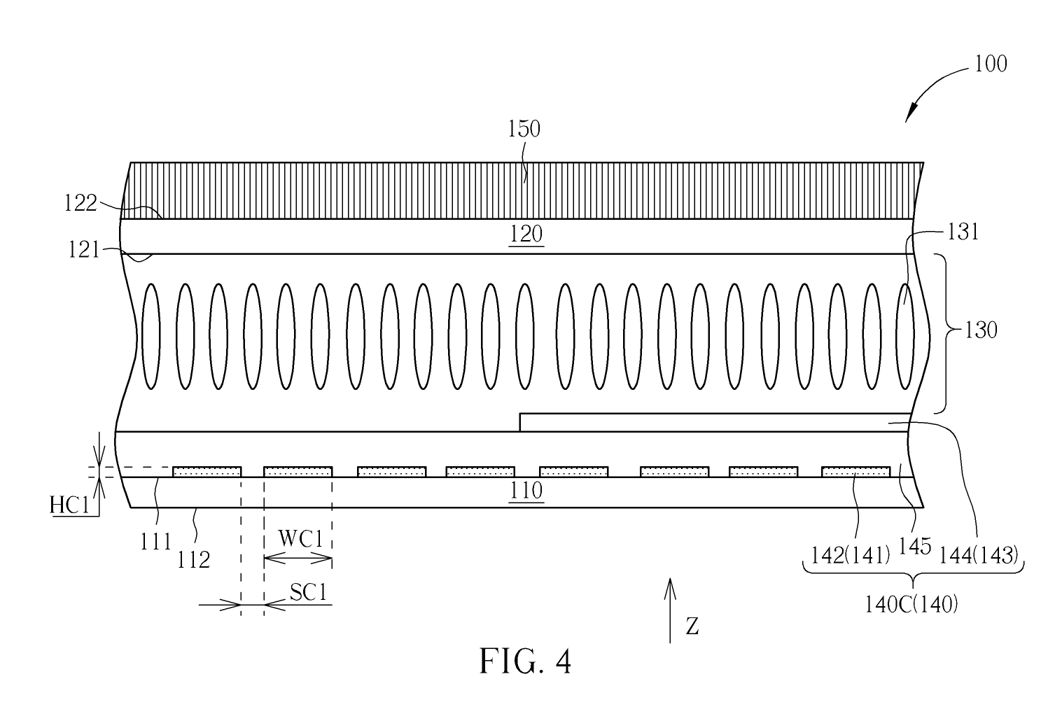

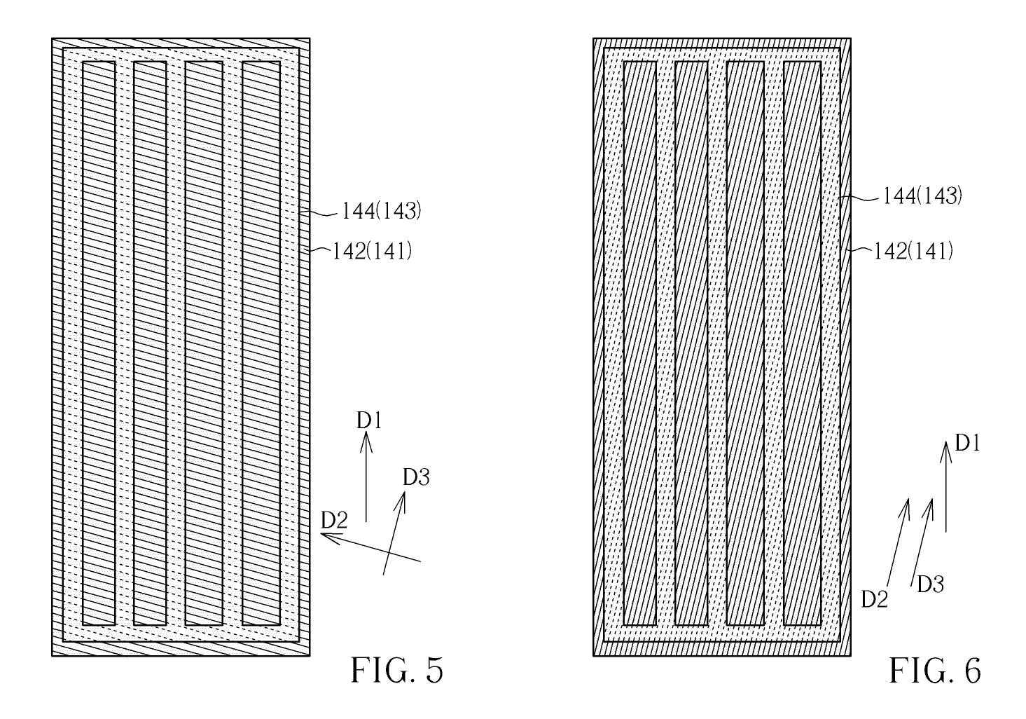

Please refer to FIGS. 1-5. FIGS. 1-4 are schematic side view diagrams illustrating a liquid crystal display panel according to a first embodiment of the invention and FIG. 5 is a schematic, partially enlarged top view diagram illustrating a liquid crystal display panel according to the first embodiment of the invention, wherein FIGS. 2-4 are partially enlarged schematic diagrams of FIG. 1. As shown in FIGS. 1 and 2-5, a liquid crystal display panel 100 comprises a first substrate 110, a second substrate 120, a polarizing film 150, a liquid crystal layer 130 and a plurality of sub-pixels 140. The first substrate 110 is disposed opposite to the second substrate 120. The first substrate 110 has a first inner surface 111 and a first outer surface 112 while the second substrate 120 has a second inner surface 121 and a second outer surface 122. The first inner surface 111 faces the second inner surface 121, and the first outer surface 112 and the second outer surface 122 are disposed back to back. The polarizing film 150 is disposed on the second outer surface 122 of the second substrate 120. The liquid crystal layer 130 is disposed between the first substrate 110 and the second substrate 120, wherein the liquid crystal layer 130 comprises a plurality of liquid crystal molecules 131. The sub-pixels 140 are disposed on the first inner surface 111 of the first substrate 110 and each of the sub-pixels 140 comprises a first patterned electrode layer 143, a second patterned electrode layer 141 and a first insulating layer 145. The first insulating layer 145 is disposed between the first patterned electrode layer 143 and the second patterned electrode layer 141. In this embodiment, the composition of the first insulating layer 145 may comprise at least one compound chosen from oxide compounds, such as silicon oxide (SiOₓ), nitride compounds, like silicon nitride (SiNₓ), selenide compounds, such as zinc selenide (ZnSe), sulfide compounds, such as zinc sulfide (ZnS) or the composite materials thereof, but are not limited thereto. The first patterned electrode layer 143 is disposed on the first substrate 110, wherein the first patterned electrode layer 143 includes a plurality of first stripe electrodes 144 extending along a first direction D1. In this embodiment, the composition of the first stripe electrodes 144 may be selected from transparent conductive materials including indium tin oxide (ITO), indium zinc oxide (IZO), aluminum zinc oxide (AZO), zinc oxide (ZnO) and tin oxide, but is not limited thereto. The second patterned electrode layer 141 is disposed on the first substrate 110 and includes a plurality of second stripe electrodes 142 extending along a second direction D2. Additionally, a portion of the first insulating layer 145 is located between the adjacent two second stripe electrodes 142. It should be noted that each of the first stripe electrodes 144 preferably overlaps the second stripe electrodes 142 along a direction Z perpendicular to the first substrate 110. It is worth noting that, in each embodiment of the invention, a relatively good display effect can be achieve by adjusting the relative orientations among the first direction D1, the second direction D2 of and an alignment direction D3. For example, each of the liquid crystal molecules 131 adjacent to the first inner surface 111 of the first substrate 110 is disposed in an alignment direction D3. The alignment direction D3 is substantially parallel or perpendicular to the second direction D2 and the second direction D2 is not parallel to the first direction D1. In this embodiment, the alignment direction D3 is substantially perpendicular to the second direction D2 while an angle between the alignment direction D3 and the first direction D1 substantially ranges form 7° to 15°, but is not limited thereto, so that the liquid crystal molecules 131 can be driven effectively.

As shown in FIG. 2, in this embodiment, a line width WA1 of each of the second stripe electrodes 142 and a spacing SA1 between two of the adjacent second stripe electrodes 142 are substantially smaller than 1 micrometer (μm) so that the second patterned electrode layer 141 may cause band-pass filtering and/or polarizing effects to light beams passing through it. Accordingly, in each embodiment of the invention, there can be only one polarizing film 150 and no lower polarizing film existing in the panel. In addition, the compositions of the second stripe electrodes 142 may be chosen from conductive materials, such as aluminum, copper, silver, gold, chromium or molybdenum, a composition thereof or an alloy thereof, but the invention may adopt other materials with suitable conductive properties. It is worth noting that, in this embodiment, the second patterned electrode layer 141 is disposed between the first patterned electrode layer 143 and the first substrate 110. However, the positions of the second patterned electrode layer 141 and the first patterned electrode layer 143 can be exchanged, if required. Additionally, in this embodiment, a ratio of a spacing SA1 between two of the adjacent second stripe electrodes 142 to a line width WA1 of each of the second stripe electrodes 142 is substantially smaller than or equal to 5, and a sum of the spacing SA1 between two of the adjacent second stripe electrodes 142 and the line width WA1 of each of the second stripe electrodes 142 is substantially smaller than or equal to 400 nm. In this case, properties caused by the second patterned electrode layer 142, such as band-pass filtering effect, polarizing effect, liquid crystal molecule driving ability and light transmittance can all be modified to other required values.

As shown in FIGS. 1-4, in this embodiment, the sub-pixels 140 can comprise a plurality of first sub-pixels 140A, a plurality of second sub-pixels 1408 and a plurality of third sub-pixels 140C. Each first sub-pixels 140A, second sub-pixels 140B and third sub-pixels 140C are arranged alternately on the first substrate 110. The first sub-pixels 140A can be used to display a first primary color, the second sub-pixels 140B can be used to display a second primary color and the third sub-pixels 140C can be used to display a third primary color. It is worth noting that the first sub-pixels 140A, the second sub-pixels 140B and the third sub-pixels 140C can display different colors through having at least one of a thickness, a line width and a spacing of two of the adjacent second stripe electrode 142 in the first sub-pixels 140A, the second sub-pixels 140B and the third sub-pixels 140C different from one another so that the first sub-pixels 140A can be used to display a first primary color, the second sub-pixels 1408 can be used to display a second primary color different from the first primary color, and the third sub-pixels 140C can be used to display a third primary color different from the first and second primary colors. For example, as shown in FIGS. 1-4, in order to have the first sub-pixels 140A to display a first primary color, such as red color, the second sub-pixels 140B to display a second primary color, such as green color and the third sub-pixels 140C to display a third primary color, such as blue color, thicknesses HA1, HB1 and HC1 of each second stripe electrode 142 in respective first sub-pixels 140A, second sub-pixels 140B and third sub-pixels 140C are different from one another. Furthermore, a width WB1 of each second stripe electrode 142 in the second sub-pixels 140B and the spacing SB1 between two second stripe electrodes 142 may also be adjusted so that they are different from a width WA1 of each second stripe electrode 142 in the first sub-pixels 140A, the spacing SA1 between two adjacent second stripe electrodes 142, a width WC1 of each second stripe electrode 142 in the third sub-pixels 140C and the spacing SC1 between two adjacent second stripe electrode 142. For instance, the thickness HA1 is approximately 172 nm, the thickness HB1 is approximately 121 nm and the thickness HC1 is approximately 94 nm; the line width WA1 may be approximately 139 nm, the line width WB1 may be approximately 141 nm and the line width WA1 may be approximately 139 nm; the spacing SA1 is approximately 12.2 nm, the spacing SB1 is approximately 10.6 nm and the spacing SC1 is approximately 12.2 nm; the ratio of the spacing SA1 to the line width WA1 is approximately 0.087, the ratio of the spacing SB1 to the line width WB1 is approximately 0.075 and the ratio of the spacing SC1 to the line width WC1 is approximately 0.087. However, the line width, the spacing and the thickness in each of the second stripe electrode 142 can be modified, if required, and should not be limited to the values described above.

Through adjusting the physical parameter (i.e. thickness, width and spacing) of the second stripe electrode 142 in each sub-pixel 140, each primary color may be mixed with on another to therefore achieve a full-color display effect. Besides, a variety of sub-pixel 140 designs may also be adopted so that the full-color display effect can be produced without the existence of conventional color filter.

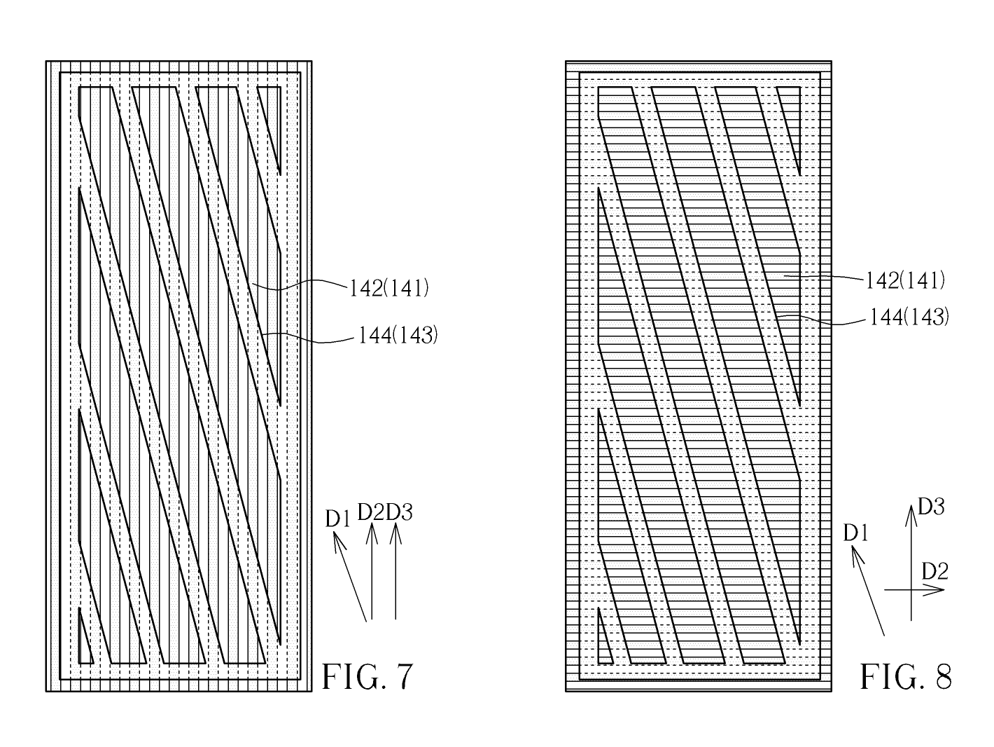

Please refer to FIGS. 6-8 accompanied with FIGS. 2-5. FIGS. 6-8 are schematic, top view diagrams illustrating the orientation of each first stripe electrode and each second stripe electrode in a liquid crystal display panel according to another embodiment of the invention. As shown in FIGS. 5-8, a relatively good display effect can be achieve by adjusting the relative orientations among a first direction D1, a second direction D2 and an alignment direction D3. For example, on the premise that the angle between the alignment direction D3 and the first direction Dl is controlled in a certain value (e.g. ranging form 7° to 15°, but is not limited thereto), the alignment direction D3 may be substantially parallel to the second direction D2 (as shown in FIGS. 6-7) or the alignment direction D3 may be substantially perpendicular to the second direction D2 (as shown in FIGS. 5 and 8). In these cases, the liquid crystal molecules 130 may be driven effectively. However, the invention should not be construed in a limiting sense. That is to say, relatively good display effect may also be achieved by adjusting the relative orientations among the first direction D1, the second direction D2 and the alignment direction D3.

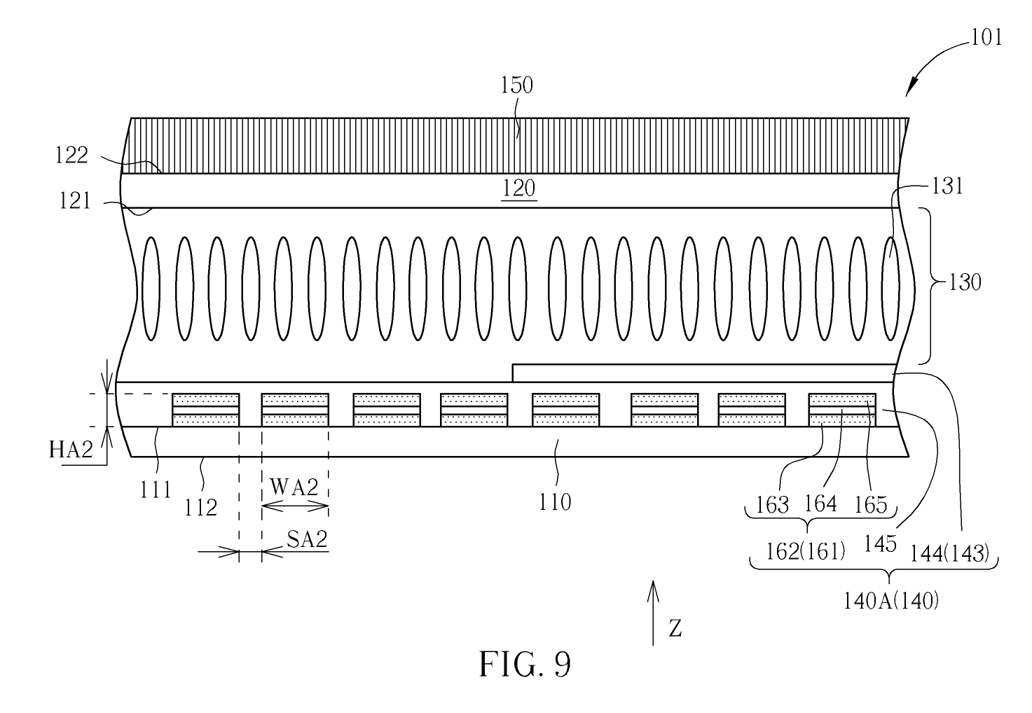

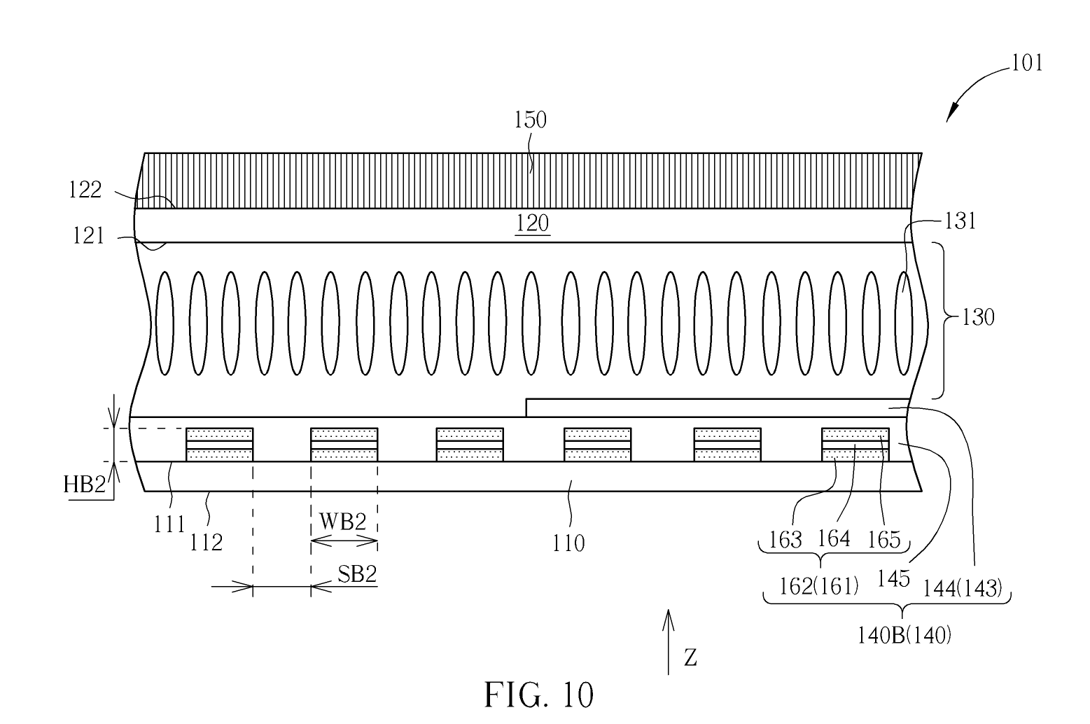

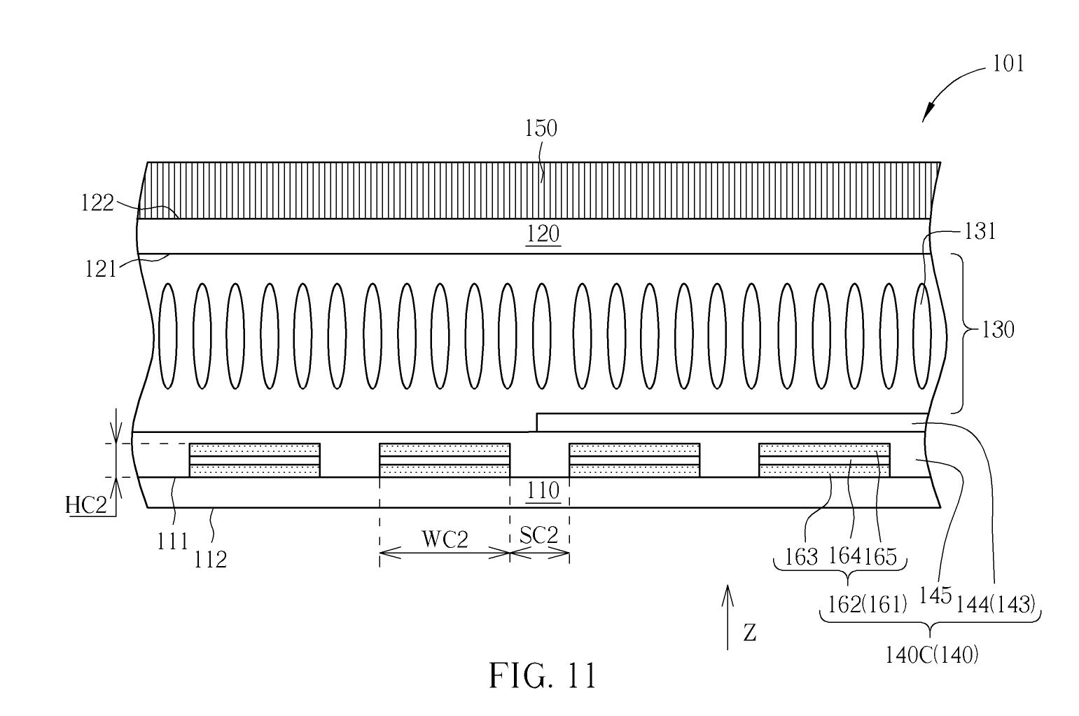

Please refer to FIGS. 9-11 accompanied with FIG. 1. FIGS. 9-11 are schematic, side view diagrams illustrating a liquid crystal display panel according to a second embodiment of the invention. As shown in FIGS. 9 and 1, the main difference between a liquid crystal display panel 101 shown in this embodiment and the liquid crystal display panel 100 described in the first embodiment is that each sub-pixel 140 comprises a first patterned electrode layer 143, a second patterned electrode layer 161, and an insulating layer 145. The second patterned electrode layers 161 comprise a plurality of second stripe electrode 162. Each of the second stripe electrodes 162 includes a first conductive layer 163, a second conductive layer 165 and a second insulating layer 164. The first conductive layer 163 is stacked with the second conductive layer 165, while the second insulating layer 164 is disposed between the first conductive layer 163 and the second conductive layer 165. In this embodiment, the compositions of the first conductive layer 163 and the second conductive layer 165 may be chosen from conductive materials, such as aluminum, copper, silver, gold, chromium or molybdenum, a composition thereof or an alloy thereof, but the invention may still adopt other materials with suitable conductive properties. In addition, the composition of the second insulating layer 164 may comprise at least one compound chosen from selenide compounds, such as zinc selenide (ZnSe), oxide compounds, such as silicon oxide (SiOₓ), nitride compounds, like silicon nitride (SiNₓ), sulfide compounds, such as zinc sulfide (ZnS) and the composite materials thereof, but are not limited thereto. In this embodiment, a line width WA2 of each of the second stripe electrodes 162 and a spacing SA2 between two adjacent second stripe electrodes 162 are substantially smaller than 1 μm so that the second patterned electrode layer 161 may provide band-pass filtering and/or polarizing effects as light beams pass through it. Since the remaining parts of the liquid crystal display panel 101 are the same as those shown in the first embodiment, for the sake of clarity, their description is therefore omitted.

It is worth noting that, as shown in FIGS. 9-11, in this embodiment, each kind of sub-pixels 140A, 140B and 140C can display different colors through having at least one of the thickness, the line width and the spacing of two adjacent second stripe electrodes 162 in the first sub-pixels 140A, the second sub-pixels 140B and the third sub-pixels 140C different from one another, so that the first sub-pixels 140A can be used to display a first primary color, the second sub-pixels 140B can be used to display a second primary color different from the first primary color, and the third sub-pixels 140C can be used to display a third primary color different from the first and second primary colors. For example, as shown in FIGS. 9-11, in order to have the first sub-pixels 140A display a first primary color, such as red color, have the second sub-pixels 140B display a second primary color, such as green color and have the third sub-pixels 140C display a third primary color, such as blue color, a line width WA2, WB2 and WC2 of each second stripe electrode 162 in respective first sub-pixels 140A, second sub-pixels 140B and third sub-pixels 140C may have different value from one another. Also, a spacing SA2, SB2 and SC2 of two adjacent second stripe electrodes 162 in respective first sub-pixels 140A, second sub-pixels 140B and third sub-pixels 140C may have different values from one another. In contrast, a thickness HA2, HB2 and HC2 of each second stripe electrode 162 in respective first sub-pixels 140A, second sub-pixels 140B and third sub-pixels 140C may have approximately the same value from one another. For instance, all the thicknesses HA1, HB1 and HC1 are approximately 180 nm; the line width WA2 may be approximately 161 nm, the line width WB2 may be approximately 189 nm and the line width WC2 may be approximately 252 nm; the spacing SA2 is approximately 69 nm, the spacing SB2 is approximately 81 nm and the spacing SC2 is approximately 108 nm; the ratio of the spacing SA2 to the line width WA2 is approximately 0.43, the ratio of the spacing SB2 to the line width WB2 is approximately 0.43 and the ratio of the spacing SC2 to the line width WC2 is approximately 0.43. However, the line width, spacing and thickness in each of the second stripe electrode 142 can be modified if required, and should not be limited to the value described above.

Additionally, the design method of second stripe electrode 162 in each of the sub-pixels 140 and the relationship between extension directions of each first stripe electrode 144 and second stripe electrode 162 are similar to that of the first embodiment; its description is therefore omitted for the sake of clarity.

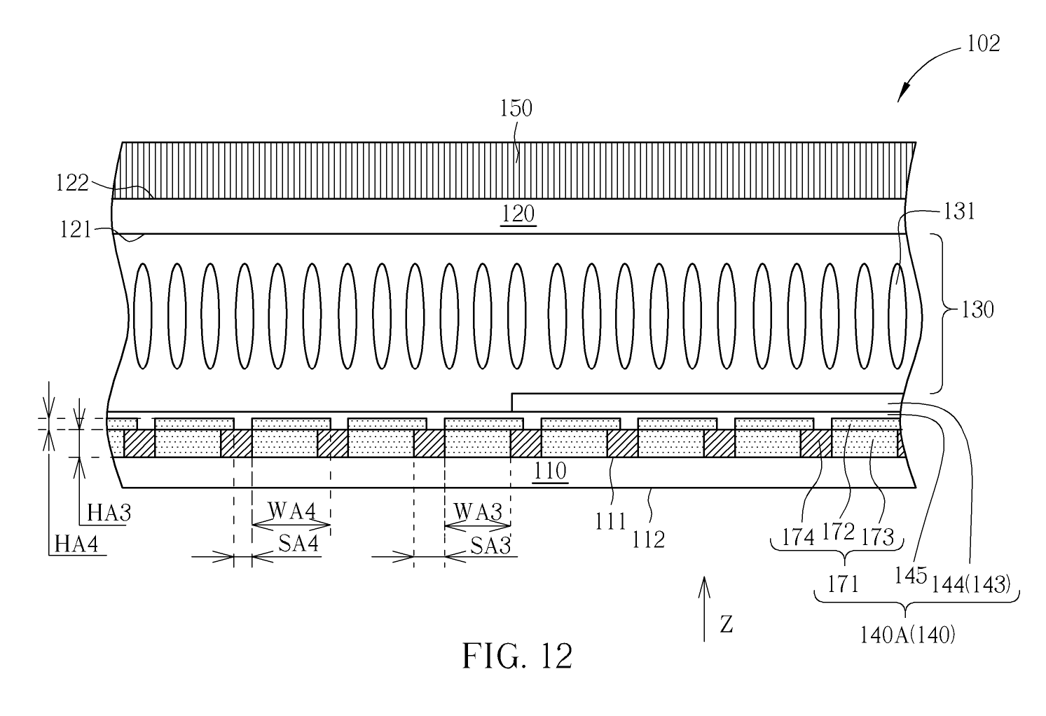

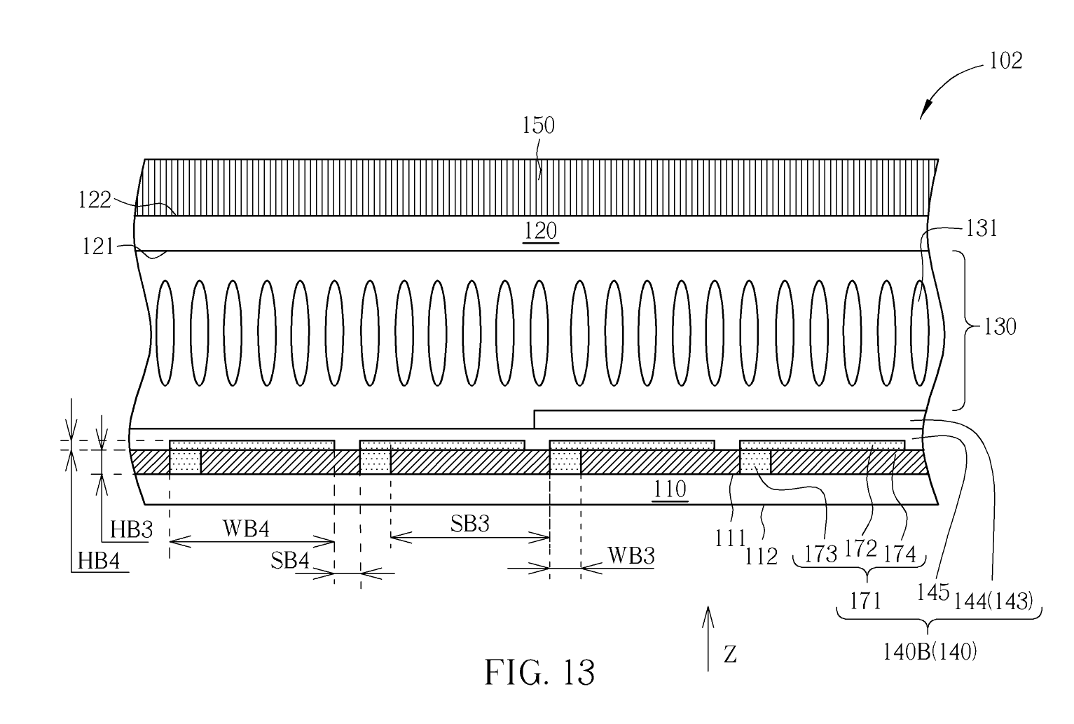

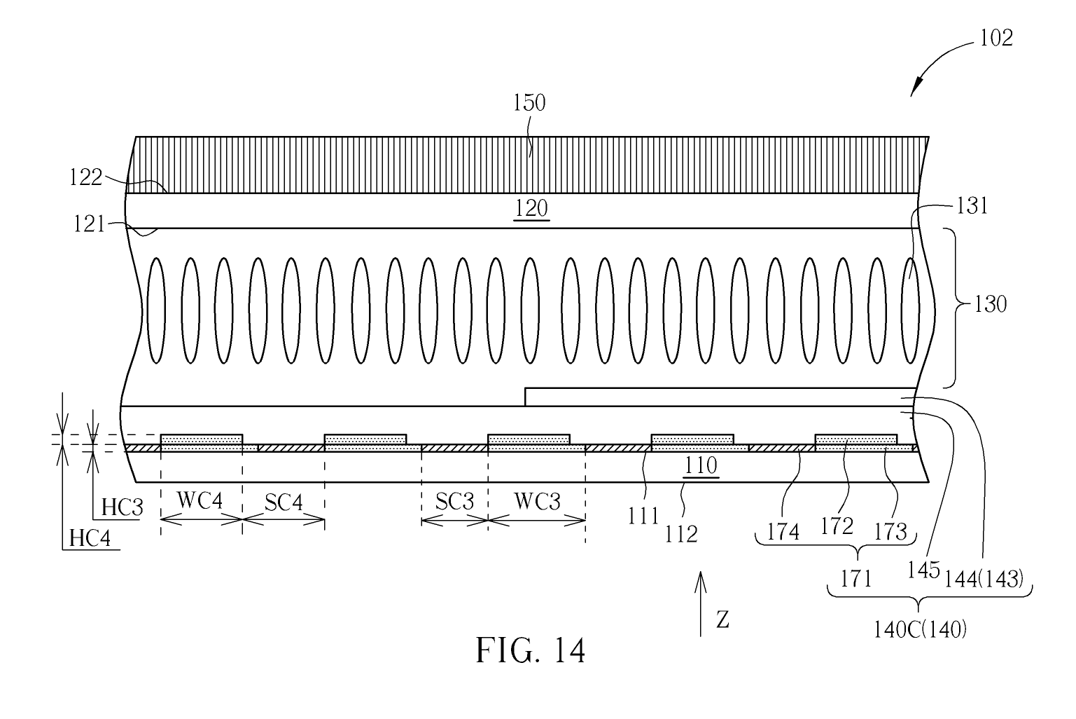

Please refer to FIGS. 12-14 accompanied with FIG. 1. FIGS. 12-14 are schematic, side view diagrams illustrating a liquid crystal display panel according to a third embodiment of the invention. As shown in FIGS. 12 and 1, the main difference between a liquid crystal display panel 102 shown in this embodiment and the liquid crystal display panel 100 described in the first embodiment is that the liquid crystal display panel 102 shown in this embodiment comprises a plurality of second stripe electrodes 172 and a plurality of third stripe electrodes 173. In this embodiment, a line width WA4 of each of the second stripe electrodes 172, a line width WA3 of each of the second stripe electrodes 173, a spacing SA4 between two adjacent second stripe electrodes 172 and a spacing SA3 between two adjacent third stripe electrodes 173 are substantially smaller than 1 μm so that a second patterned electrode layer 171 may provide band-pass filtering and/or polarizing effects as light beams passing through it. In this embodiment, the compositions of the second stripe electrodes 172 and the third stripe electrodes 173 may be chosen from conductive materials, such as aluminum, copper, silver, gold, chromium or molybdenum, a composition thereof or an alloy thereof, but the invention may still adopt other materials with suitable conductive properties. In addition, the second patterned electrode layer 171 further comprises a third insulating layer 174 disposed between the first substrate 110 and the first insulating layer 145. The composition of the third insulating layer 174 may comprise at least one compound chosen from silicon, selenide compounds, such as zinc selenide (ZnSe), oxide compounds, such as silicon oxide (SiOₓ), nitride compounds, like silicon nitride (SiNₓ), sulfide compounds, such as zinc sulfide (ZnS) and the composite materials thereof, but are not limited thereto. In this embodiment, a line width WA3 of each of the third stripe electrodes 173 is substantially different from the line width WA4 of each of the second stripe electrodes 172, and the third insulating layer 174 is disposed between each of the third stripe electrodes 173. That is to say, through adjusting the spacing SA3 between two adjacent third stripe electrodes 173, band-pass filtering effect provided by the second patterned electrode layer 171 may be altered. Since the remaining parts of the liquid crystal display panel 102 are the same as those shown in the first embodiment, for the sake of clarity, their description are therefore omitted. It is worth noting that, through having at least one of the thickness, the line width and the spacing of the second stripe electrode 172 and the third stripe electrode 173 in the first sub-pixels 140A, the second sub-pixels 140B and the third sub-pixels 140C different from one another, the first sub-pixels 140A can be used to display a first primary color, the second sub-pixels 140B can be used to display a second primary color different from the first primary color, and the third sub-pixels 140C can be used to display a third primary color different from the first and second primary colors.

For example, as shown in FIGS. 12-14, in order to have the first sub-pixels 140A display a first primary color, such as red color, have the second sub-pixels 140B display a second primary color, such as green color and have the third sub-pixels 140C display a third primary color, such as blue color, thicknesses HA4, HB4 and HC4 of each second stripe electrode 172 in respective first sub-pixels 140A, second sub-pixels 140B and third sub-pixels 140C are different from one another. Furthermore, widths WB4, WB4 and WC4 of each second stripe electrode 172 in respective first sub-pixels 140A, second sub-pixels 140B and third sub-pixels 140C are different from one another. In addition, spacings SA4, SB4 and SC4 between each second stripe electrode 172 in respective first sub-pixels 140A, second sub-pixels 140B and third sub-pixels 140C are different from one another. In respect to the third stripe electrodes 173, thicknesses HA3, HB3 and HC3 of each third stripe electrodes 173 in respective first sub-pixels 140A, second sub-pixels 140B and third sub-pixels 140C are different from one another. Furthermore, widths WB3, WB3 and WC3 of each third stripe electrodes 173 in respective first sub-pixels 140A, second sub-pixels 140B and third sub-pixels 140C are different from one another. In addition, spacings SA3, SB3 and SC3 between each third stripe electrodes 173 in respective first sub-pixels 140A, second sub-pixels 140B and third sub-pixels 140C are different from one another. For instance, the thickness HA3 is approximately 212 nm, the thickness HB3 is approximately 219 nm and the thickness HC3 is approximately 147 nm; the thickness HA4 is approximately 101 nm, the thickness HB4 is approximately 132 nm and the thickness HC4 is approximately 10 nm; the line width WA3 may be approximately 8.9 nm, the line width WB3 may be approximately 4.7 nm and the line width WC3 may be approximately 53.6 nm; the spacing SA3 is approximately 38.1 nm, the spacing SB3 is approximately 112.3 nm and the spacing SC3 is approximately 26.4 nm; the line width WA4 may be approximately 38.5 nm, the line width WB4 may be approximately 87.8 nm and the line width WA4 may be approximately 47.2 nm; the spacing SA4 is approximately 8.5 nm, the spacing SB4 is approximately 29.3 nm and the spacing SC4 is approximately 32.8 nm; the ratio of the spacing SA4 to the line width WA4 is approximately 0.22, the ratio of the spacing SB4 to the line width WB4 is approximately 0.33 and the ratio of the spacing SC4 to the line width WC4 is approximately 0.69. However, the line widths, spacing and thicknesses in each of the stripe electrodes 172 and 173 can be modified if required, and should not be limited to the values described above. Since the design of the each second stripe electrodes 172 in each sub-pixel 140 and the orientation relationship between the first stripe electrodes 144 and the second stripe electrodes 172 are the same as that described in the first embodiment, for the sake of clarity, they are therefore omitted.

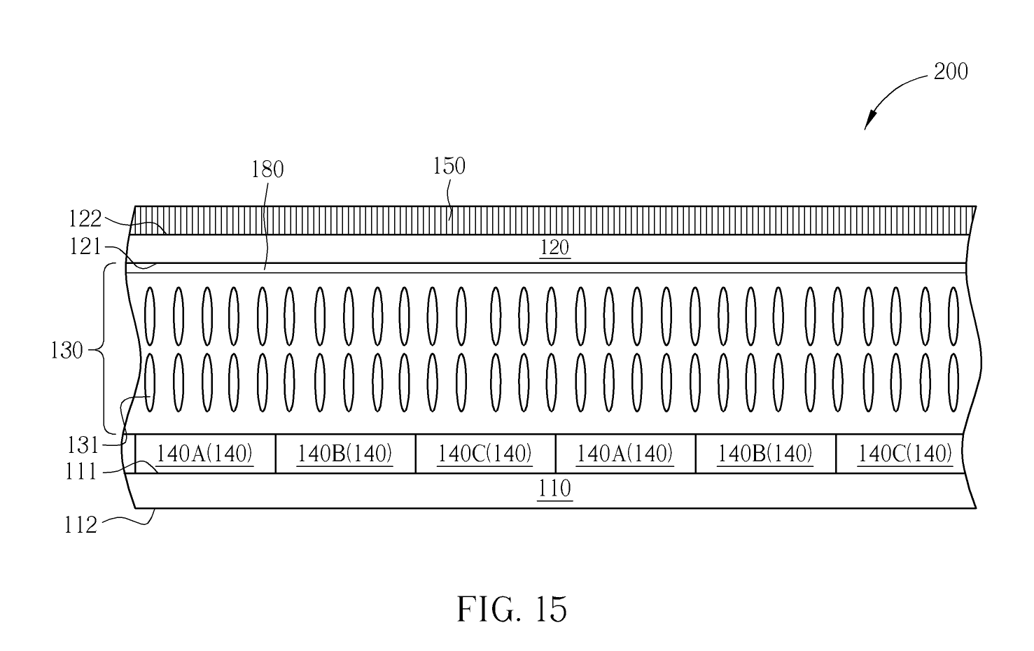

Please refer to FIG. 15 accompanied with FIG. 1. FIG. 15 is a schematic, side view diagram illustrating a liquid crystal display panel according to a fourth embodiment of the invention. As shown in FIGS. 15 and 1, the main difference between a liquid crystal display panel 200 shown in this embodiment and the liquid crystal display panel 100 described in the first embodiment is that the liquid crystal display panel 200 shown in this embodiment further comprises a color filter 180 located on the second inner surface 121 of the second substrate 120. That is to say, each sub-pixel 140 has the ability to polarize light beams so that all second patterned electrode layers (not shown) in each first sub-pixels 140A, each second sub-pixels 140B and each third sub-pixels 140C can have the same design. In addition, in order to match up with the color filter 180, the second patterned electrode layer, may be adjusted to have the design layouts illustrating in the preceding embodiments if required. Except for the color filter 180, the features and material characteristics of the remaining parts of the liquid crystal display panel 200 are similar to those described in the preceding paragraph. For the sake of clarity, the similar parts are therefore omitted

In sum, the present invention provides a liquid crystal display panel, where an electrode layer, used to alter the orientation of liquid crystal molecules, has a stripe electrode with nano-scaled line widths and spacing. By adjusting line widths, spacing and thickness of the nano-scaled stripe electrode, the electrode layer can provide desired band-passing filtering and/or polarizing effects and replace color filters and polarizing films. Accordingly, it can simplify a structure of the panel and improve overall light transmittance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display panel, comprising:
a first substrate having a first inner surface and a first outer surface;
a second substrate disposed opposite to the first substrate and having a second inner surface and a second outer surface, wherein the first inner surface faces the second inner surface, and the first outer surface and the second outer surface are disposed back to back;
a polarizing film disposed on the second substrate;
a liquid crystal layer disposed between the first substrate and the second substrate, wherein the liquid crystal layer comprises a plurality of liquid crystal molecules; and
a plurality of sub-pixels disposed on the first inner surface of the first substrate, and each of the sub-pixels comprising:
a first patterned electrode layer disposed on the first substrate, wherein the first patterned electrode layer includes a plurality of first stripe electrodes extending along a first direction;
a second patterned electrode layer disposed on the first substrate and including a plurality of second stripe electrodes extending along a second direction, wherein each of the first stripe electrodes overlaps the second stripe electrodes in a direction perpendicular to the first substrate; and
a first insulating layer disposed between the first patterned electrode layer and the second patterned electrode layer.

2. The liquid crystal display panel according to claim 1, wherein a line width of each of the second stripe electrodes and a spacing between two of the adjacent second stripe electrodes are substantially smaller than 1 micrometer (μm).

3. The liquid crystal display panel according to claim 1, wherein the second direction is not parallel to the first direction.

4. The liquid crystal display panel according to claim 1, wherein the second patterned electrode layer is disposed between the first patterned electrode layer and the first substrate.

5. The liquid crystal display panel according to claim 1, wherein each of the second stripe electrodes includes a first conductive layer, a second conductive layer and a second insulating layer, the first conductive layer is stacked with the second conductive layer, while the second insulating layer is disposed between the first conductive layer and the second conductive layer.

6. The liquid crystal display panel according to claim 1, wherein a ratio of a spacing between two of the adjacent second stripe electrodes to a line width of each of the second stripe electrodes is substantially less than or equal to 5.

7. The liquid crystal display panel according to claim 1, wherein a sum of a spacing between two of the adjacent second stripe electrodes and a line width of each of the second stripe electrodes is substantially smaller than or equal to 400 nanometer (nm).

8. The liquid crystal display panel according to claim 1, wherein each of the liquid crystal molecules adjacent to the first inner surface of the first substrate is aligned in an alignment direction, and the alignment direction is substantially parallel or perpendicular to the second direction.

9. The liquid crystal display panel according to claim 1, wherein the sub-pixels include a plurality of first sub-pixels, a plurality of second sub-pixels and a plurality of third sub-pixels, and at least one of a thickness of each of the second stripe electrode, a line width between each of the second stripe electrodes and a spacing between two of the adjacent second stripe electrodes of the first sub-pixels, the second sub-pixels and the third sub-pixels is different from one another so that the first sub-pixels is used to display a first primary color, the second sub-pixels is used to display a second primary color different from the first primary color, and the third sub-pixels is used to display a third primary color different from the first and second primary colors.

10. The liquid crystal display panel according to claim 1, wherein the second patterned electrode layer further comprises a plurality of third stripe electrodes, a line width of each of the third stripe electrodes and a spacing between two of the adjacent third stripe electrodes are substantially smaller than 1 μm and the line width of each of the third stripe electrodes is substantially different from a line width of each of the second stripe electrodes.

11. The liquid crystal display panel according to claim 10, wherein the second patterned electrode layer further comprises a third insulating layer disposed between the first substrate and the first insulating layer.

12. The liquid crystal display panel according to claim 10, wherein the sub-pixels include a plurality of first sub-pixels, a plurality of second sub-pixels and a plurality of third sub-pixels, and at least one of a thickness of each of the second stripe electrodes, a line width of each of the second stripe electrodes, a spacing between two of the adjacent second stripe electrodes, a thickness of each of the third stripe electrodes, a line width of each of the third stripe electrodes and a spacing between two of the adjacent third stripe electrodes of the first sub-pixels, the second sub-pixels and the third sub-pixels is different from one another so that the first sub-pixels is used to display a first primary color, the second sub-pixels is used to display a second primary color different from the first primary color, and the third sub-pixels is used to display a third primary color different from the first and second primary colors.
